(19) United States
(12) Patent Application Publication
(10) Pub. No.: US 2009/0262727 A1
(43) Pub. Date: Oct. 22, 2009

(54) Communication system

(76) Inventors: Madis Kaal, Tallinn (EE); Aram Nicholas Babaian, London (GB)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/157,170

(22) Filed: Jun. 6, 2008

(30) Foreign Application Priority Data
Apr. 17, 2008 (GB) GB 0807041.9

(51) Int. Cl. H04L 12/66

(52) U.S. Cl. 370/352; 370/400

(57) ABSTRACT

A method of initiating a call from a device executing a client program via an access network is provided. The method comprises providing a network node with information associated with the device, receiving from the network node an indication of whether at least one access number for accessing the access network is available, wherein the availability of the access number is based on the information associated with the device, and selectively enabling an input means to receive a selection signal from a user of said device to initiate the call using the access number, wherein the input means is only enabled if it is indicated that the access number is available.

### RELATED APPLICATION

This application claims priority under 35 U.S.C. §119 or 365 to Great Britain, Application No. 0807041.9, filed Apr. 17, 2008. The entire teachings of the above application are incorporated herein by reference.

### TECHNICAL FIELD

The present invention relates to a method for initiating a communication in a communication system.

### BACKGROUND

Communication systems link together communication devices so that the devices can send information to each other in a call or other communication event. Information may include voice, text, images or video.

Peer-to-peer systems and other communication systems that use the internet or any other packet switched network employ voice over IP (internet protocol) protocols (VoIP) to transmit data. These systems are commonly referred to as VoIP systems. VoIP systems are beneficial to the user as they are often of significantly lower cost than communication networks, such as fixed line or mobile networks, otherwise referred to as public switched telephone networks (PSTN). This may particularly be the case for long distance calls.

In a communication system, such as a peer to peer system, client software is installed on an end user device such as a personal computer (PC) to allow the end user to communicate via the peer to peer system. A PC connected to the internet may execute the client software to initiate communication events such as voice calls, and instant messages (IM), otherwise referred to as chat messages.

Client software may also be installed on end user devices such as mobile phones that have a limited packet switched data connection, such as a GPRS (general packet switched) data connection to the internet. In this case it is possible to provide the client software with access numbers to initiate a voice call to the peer to peer system via the PSTN network. Other data, such as IM messages may be transmitted via the packet switched data connection.

Access numbers may be provided to the client program from a network session node during a communication session between the client program and the network session node.

In some cases access numbers may not be available to the user device. For example, the user device may be located in a country where the access numbers are not available. The client software provided in a country where access numbers are not available will not be designed to support call initiation using access numbers. In this case features such as displaying the option of placing a call to a user will not be included in the software.

If the user device enters a country where access numbers are available, or if the access numbers become available in the country where the user device is located, in order to use the access numbers the user is required to install a version of the client program that supports call initiation using access numbers.

Furthermore the communication system provider is obliged to provide at least one version of the client software that does not support call initiation using access numbers and at least one other version of the client software that does support call initiation using access numbers.

Installing different versions of client software is both time consuming and is not user friendly. Some users may choose not to install new versions of the software and as such may stop using the user device.

It is therefore an aim of embodiments of the invention to address the above identified problems.

### SUMMARY

According to a first aspect of the invention there is provided a method of initiating a call from a device executing a client program via an access network comprising; providing a network node with information associated with the device; receiving from the network node an indication of whether at least one access number for accessing the access network is available, wherein the availability of the access number is based on the information associated with the device; and selectively enabling an input means to receive a selection signal from a user of said device to initiate the call using the access number, wherein the input means is only enabled if it is indicated that the access number is available.

According to a second aspect of the invention there is provided a device arranged to execute a client program for to initiating a call via an access network, said device comprising; transmitting means arranged to provide a network node with information associated with the device; receiving means arranged to receive from the network node an indication of whether at least one access number for accessing the access network is available, wherein the availability of the access number is based on the information associated with the device; and selectively enabled input means arranged to receive a selection signal from a user of said device to initiate the call using the access number, wherein the input means is only enabled if it is indicated that the access number is available.

### BRIEF DESCRIPTION OF THE DRAWINGS

For a better understanding of the present invention and as to how the same may be carried into effect, embodiments of the present invention will now be described by way of example only with reference to the following drawings:

FIG. 1 is a schematic representation of a communication network in accordance with an embodiment of the invention;

FIG. 2a is a diagram showing the protocol stack of a client program in accordance with an embodiment of the present invention;

FIG. 2b is a diagram of a user device in accordance with an embodiment of the present invention;

FIG. 3 is a diagram showing the client user interface displayed on the user device 102;

FIG. 4a is a further diagram showing the client user interface displayed on the user device;

FIG. 4b is a further diagram showing the client user interface displayed on the user device;

FIG. 5 is a schematic representation of part of the communication network shown in FIG. 1;

FIG. 6 is flow diagram showing a method according to an embodiment of the invention;

FIG. 7a is a further diagram showing the client user interface displayed on the user device;

FIG. 7b is a further diagram showing the client user interface displayed on the user device;

FIG. 8 is a diagram showing the initiation of a call using an access number.

### DETAILED DESCRIPTION

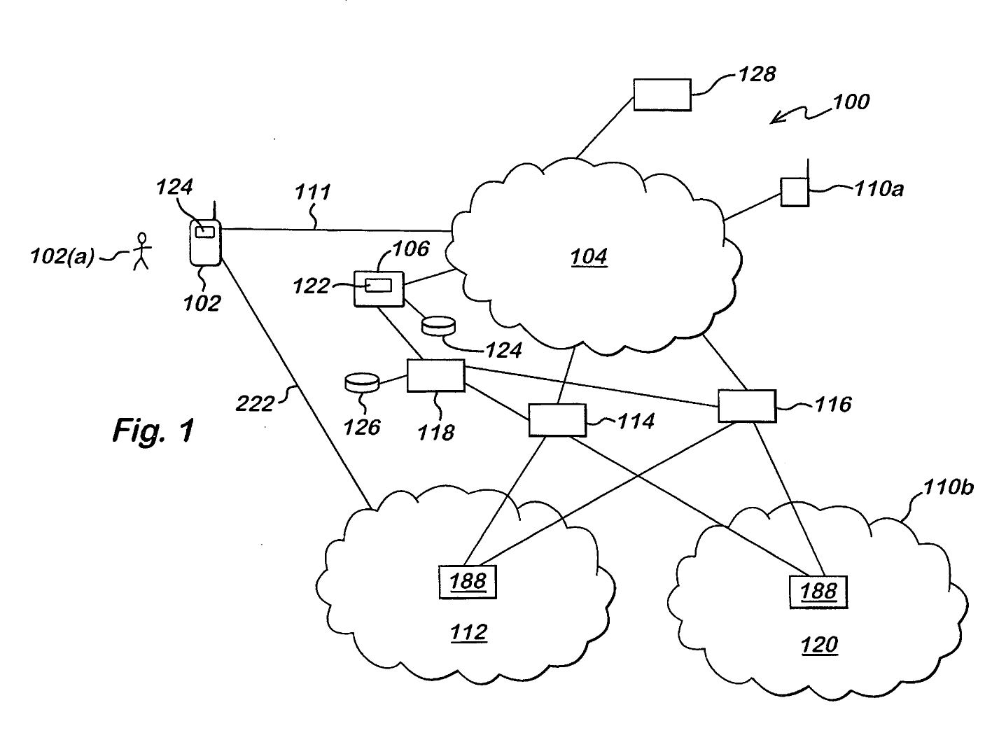

Reference will first be made to FIG. 1, in which is shown a communication network 100, including a packet switched communication system 104 and circuit switched networks 112 and 120. In one embodiment the packet switched communication system 104 may be a peer to peer system operating on a packet switched network such as the internet. The circuit switched networks 112, 120 may be PSTN (Public Switched Telephone Network) networks such as wireless cellular networks and fixed line networks.

A user device 102 is shown to be connected to the peer to peer system 104 via a session node 106 connected to the internet. The user device 102 is also connected to the PSTN network 120. In one embodiment of the invention the user device is connected to the PSTN network 112 via a circuit switched connection 222 and to the session node 106 via a packet switched connection 111. The circuit switched connection 222 and the packet switched connection 111 may be provided by a GSM (Global System for Mobile Communications) network (not shown). For example the packet switched connection may be provided by a GPRS (General Packet Radio Service) connection of the GSM network whilst the circuit switched connection may be provided by a GSM audio connection of the GSM network. In a preferred embodiment of the invention the packet switched connection 111 is used to transmit packet data according to an internet protocol such as Transmission Control Protocol (TCP). In an alternative embodiment of the invention the user device 102 may be connected to the internet and to the PSTN networks 112 and 120 via a UTRAN (UMTS (Universal Mobile Telecommunications System) Terrestrial Radio Access Network).

The user device 102 may be, for example, a personal computer, a gaming device, a personal digital assistant, a suitably enabled mobile phone, or other device able to connect to the internet.

The session node 106 runs a communication instance 122 defining a session dedicated to a user 102a of the user device 102. The communication instance 122 enables the user 102a of the user device 102 to communicate across the communication network 100 to establish a connection with another device such as a device 110a connected to the peer to peer system 104 or a device 110b connected to a PSTN network 120. It should be appreciated that the session node 106 is able to run a plurality of communication instances for a plurality of concurrent user devices located in a plurality of countries. However for clarity only one communication instance is illustrated as running on the session node 106.

As shown in FIG. 1 the peer to peer system on the internet 104 comprises an inbound node 114 and an outbound node 116. The inbound node 114 and the outbound node 116 are connected to PSTN gateways 188 located in the PSTN networks. The inbound node 114 is arranged to receive data for the peer to peer system on the internet 104 from the PSTN gateways 188. The outbound node 116 is arranged to forward data from the peer to peer system on the internet 104 to the to the PSTN gateways 188.

Also shown in FIG. 1 is a contact list node 128. The contact list node 128 is responsible for storing a contact list associated with each user of the peer to peer system. The contact list comprises the identities of other users of the communication system stored as contacts by a user.

The user device 102 runs a client program 124 on a processor for communicating with the communication instance 122 in order to establish a communication event such as a voice call or a video call, or the transmission of an IM (instant message) with another device via the communication network 100.

Communication events may be carried out exclusively via packet switched connections using the data connection 111 and the internet. Alternatively communication events may be routed to the internet via the PSTN network 120. In order to establish a call, such as a voice call or video call, via the PSTN network, the client program 124 requires a PSTN access number. According to one embodiment of the invention all calls initiated at the user device using the client program are routed via the PSTN network. The provision of access numbers will be described in detail hereinafter.

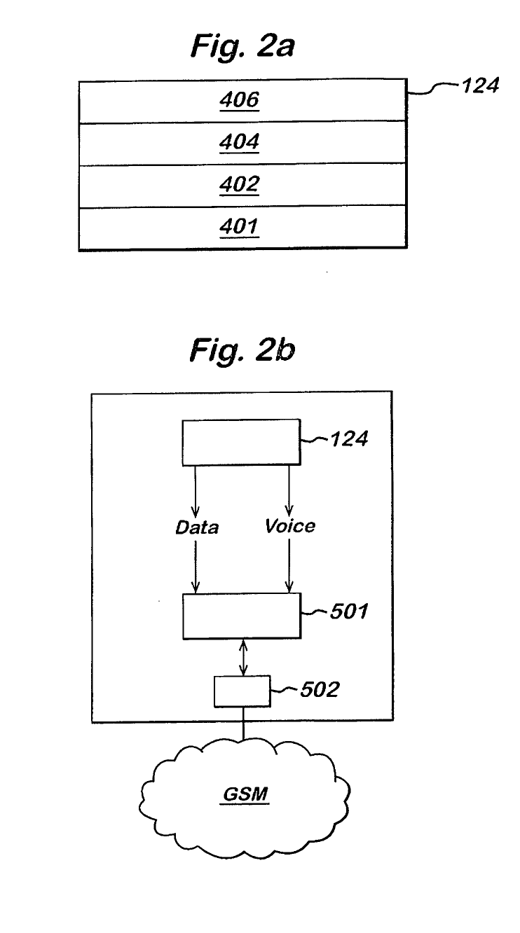

The client program 124 running on the processor of the user device has a number of different components or layers for implementing various functions, including a protocol layer 402 (FIG. 2a) for managing the interface with the GSM network. The interface with the GSM network will be described hereinafter with reference to FIG. 2b.

FIG. 2a shows a protocol stack for the client program 124 according to an embodiment of the present invention.

The protocol stack shows an operating system layer 401, a protocol layer 402, a client engine layer 404 and a client user interface layer 406. Each layer is responsible for specific functions. Because each layer usually communicates with two other layers, they are regarded as being arranged in a stack as shown in FIG. 2a. The operating system layer 401 manages the hardware resources of the user device 102 and handles data being transmitted to and from the session node 106. The operating system layer also handles the data being transmitted to and from the network 112. The client protocol layer 402 of the client software communicates with the operating system 401. Processes requiring higher level processing are passed to the client engine layer 404. The client user interface layer 406 defines the information that is presented to the user 102a of the user terminal 102.

The client engine 404 communicates with the client user interface layer 406. The client engine may be arranged to control the client user interface layer 406 to present communication options to the user via the user interface means of the user device and to receive instructions from the user via the user interface means of the device. The user interface means of the user device may comprise a speaker, a microphone, a display screen and a keyboard. This list is not exhaustive.

FIG. 2b is a schematic diagram showing the transmission of data between the client protocol stack and the GSM protocol stack in the user device 102. As shown in FIG. 2b the user device 102 further comprises a GSM protocol stack 501 and a radio transceiver 502. Information transmitted from the GSM network to the user device is received by the transceiver 502. The data received from the GSM network is processed by GSM protocol stack 501 before it is transmitted to the client program 124. Similarly, information to be transmitted to the GSM network from the client program 124 is processed by the GSM protocol stack 501 before it is transmitted to the GSM network via the transceiver 502. The operation of the GSM protocol stack 501 is known in the art and will not be described in detail herein.

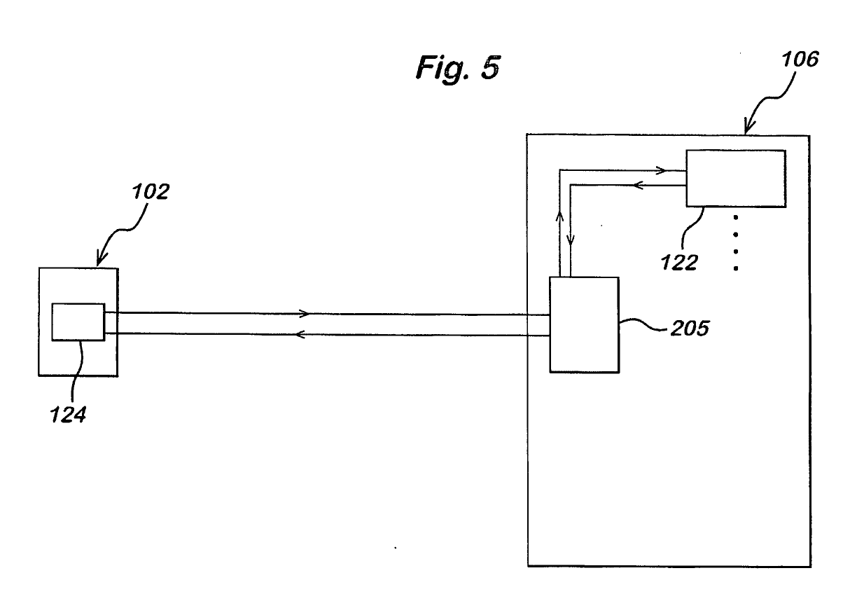

The communication instance 122 running on the session node 106 manages the communication between the client program 124 running on the device 102 and the peer to peer system on the internet 104. FIG. 5 shows the communication path between the communication instance 122 on the session node 106 and the client program 124 running on the user device 102.

As shown in FIG. 5, the session node 106 further comprises a core module 205 for allocating a communication instance 122 to a client program 124. When a client program 124 transmits a login request to the session node 106, via the internet, the core module 205 is arranged to assign a communication instance 122 to the client program 122. The session node 106 is arranged to disassociate the communication instance 122 from the client program 124 when the client program transmits a logout request, or when the client program has not communicated with the communication instance for a predetermined time.

The client program 124 running on the user device 102 is arranged to set up a secure connection with the session node 106 using an encryption method, Encryption methods are known in the art and will not be described further herein.

When a secure connection has been established the client program 124 is arranged to send the session node 106 data relating to the user device 102 in a ‘client data’ data packet. The ‘client data’ data packet may include the attributes listed in table 1:

TABLE 1

| KEY | TYPE | ATTRIBUTE |
|---|---|---|
| CHUNKTYPE | integer | CLIENT DATA |
| CLIENT_IP_ADDRESS | address | device IP address |
| DEVICE_PSTNNUMBER | string | device PSTN number |
| | | in international notation. |

As shown in table 1, the ‘client data’ packet includes an attribute defining an IP address of the user device and an attribute defining a PSTN number of the device. The IP address of the device identifies the user device 102 in the packet switched network provided by the internet. Similarly the PSTN address identifies the user device 102 in the PSTN network 112.

Once the client program has verified any credentials of the session node 106 the client program may then log into the peer to peer system via the session node 106. The client program running on the user device 102 may log into the peer to peer system by transmitting the login details of the user 102a to the session node 106. On login the core module 205 will assign a dedicated communication instance 122 to the client program 124. This defines the start of a session between the client program and the session node 106.

When the client program 124 running on the user device 102 has logged into the peer to peer system, the session node 106 provides the client program with the contact list associated with the user 102a. The session node is arranged to retrieve the contact list from the contact list node 128.

Once the session node 106 has assigned a communication instance 122 to the client program 124, the communication instance 122 will optionally provide the client program 124 with at least one access number to enable to the client program 124 to establish a call with an entity via the PSTN network 112.

The entity may be any node in the communication system 100 that is capable of receiving information from the user device 102. For example the entity may be another user device in the communication system 100 such as the user device 110a or 110b. The entity may correspond to voice mail records, or other data records associated with the user of the user device. An entity may be a node arranged to carry out control commands in the network.

The provision of access numbers to enable the client program to establish a call with an entity is dependent on the location of the user device 102. In accordance with an embodiment of the invention, the session node is arranged to determine if the user device 102 is located in a country where access numbers are available. If it is determined that access numbers are available the session node 106 is arranged to provide an indication to the client program that access numbers are available. If however the session node determines that the user device is located in a country where access numbers are not available, the session node may be arranged to provide an indication to the client program that access numbers are not available.

The location of the user device 102 may be determined, for example, from the country code of the PSTN number associated with the device 102. Alternatively the location may be determined from GPS (Global Positioning System) data transmitted from the user device to the session node. Alternatively the location of the device 102 may be determined using known location methods that analyze the IP address of the device to look up the location of the device.

In one embodiment of the invention the session node 106 is arranged to refer to a look up table stored in a data store 129 to determine whether access numbers are available for use in the location of the user device. Information in the look up table may be maintained by the provider of the peer to peer system.

In an alternative embodiment of the invention a call manager 118 is arranged to determine if access numbers are available, as will be described hereinafter.

In accordance with a further embodiment of the invention the provision of access numbers to enable the client program to establish a call with the contact is dependent on the capability of the user device 102 to make a call. For example the user device may be a gaming device that is not capable of making PSTN calls. The identity of the device may be reported by the device to the session node 106. The session node is arranged to determine if the user device 102 is capable of making PSTN calls from the identity of the device. If it is determined that the user device is capable of making PSTN calls the session node 106 is arranged to provide an indication to the client program that access numbers are available. If however the session node determines that the user device is not capable of making PSTN calls, the session node may be arranged to provide an indication to the client program that access numbers are not available.

If it is determined that access numbers may be provided to the user device the communication instance 122 is arranged to request the access numbers from the call manager 118.

The call manager 118 shown in FIG. 1 is arranged to provide the communication instance 122 with an access number to be allocated to an entity in response to a request from the communication instance. Upon receipt of the access number from the call manager, the communication instance is arranged to allocate the access number to the entity and to provide the address of the entity to the call manager. The call manager is arranged to store the allocated access number in a data store 126 in association with the address of the entity and the PSTN number of the user device 102.

If the entity is stored as a contact in the user's contact list the address of the entity may be determined by the communication instance from the contact list node 128. Alternatively the address of the entity may be input by the user into the user device 102 and transmitted from the user device 102 to the session node 106. The address of an entity that resides in the internet such as user device 110a may be for example an IP address, a URI (Uniform Resource Indicator), a username, or a VoIP device. The address of an entity that resides in the PSTN network may be the PSTN number associated with the entity.

In accordance with an embodiment of the invention, if it is determined that access numbers may be provided to the client program, a data packet is transmitted to the client program from the session node to indicate that access numbers are available.

The availability of access numbers may be indicated by the transmission of a call set up data packet from the session node 106 to the client program 124. According to this embodiment of the invention the client program may be arranged to determine that access numbers are available on receipt of the call set up data packet. Conversely, if a call set up data packet is not received by the client program, the client program is arranged to determine that access numbers are not available.

The call set up data packet may comprise the attributes listed in table 2:

TABLE 2

| KEY | TYPE | ATTRIBUTE |
|---|---|---|
| CHUNKTYPE | integer | CALLSETUP |
| CALLMETHOD | integer | a numeric value |
| | | identifying |
| | | calling method to use |
| DIALIN_NUMBER_PREFIX | string | first number in dial-in |
| | | number range, for |
| | | example |
| | | “ +3725521000” |
| DIALIN_NUMBER_RANGE_SIZE | integer | # of numbers in |
| | | dial-in block, for |
| | | example 1000 |

A plurality of access numbers may be provided to the client program 124. Each access number for calling an entity may be listed separately in the call set up data packet. However in a preferred embodiment, each access number may be determined by the client program 124 from a first number corresponding to a ‘DIAL IN NUMBER PREFIX’ and a second number corresponding to an index number identifying the contact in the contact list. The index number will fall within the number range, referred to as the ‘DIAL IN NUMBER RANGE’ as shown in table 2.

The index number for each contact is transmitted in the contact list from the communication instance 122 to the client program 124.

The client program 124 may map an access number to each entity in the contact list by arithmetically adding the first number to the index for the entity. For example if the first number is defined as:
+3725521020
   and the index for a contact is:
33
   the access number mapped to the contact will be:
+3725521053

Alternatively the client program may map the access number to the contact by appending the index to the first number. For example, if the first number is:
+37255210
   and the index corresponding to an contact is:
33
   the access number mapped to the contact will be:
+3725521033

Alternatively if the access numbers are provided as a list of complete access numbers the position of the access number in the list may be mapped to an entity having a corresponding index.

In an alternative embodiment only one access number is provided in the call set up data packet. The user of the user device may then enter the index of the contact in the contact list using DTMF (Dual-Tone Multi-Frequency) tones when the user device has established a call connection.

In accordance with a further embodiment of the invention the availability of access numbers may be indicated by the inclusion of access numbers in the call set up data packet. According to this embodiment of the invention the client program is arranged to determine that access numbers are available if access numbers are included in the call set up data packet. Conversely, if the call set up data packet does not contain access numbers the client program is arranged to determine that access numbers are not available.

In accordance with a further embodiment of the invention the availability of access numbers may be indicated by a flag included in the call set up data packet. According to this embodiment of the invention the client program is arranged to determine that access numbers are available if the flag in the call set up data packet indicates that access numbers are available.

In response to receiving an indication of whether access numbers are available, the client program is arranged to store information on the availability of access numbers in a data store of the user device.

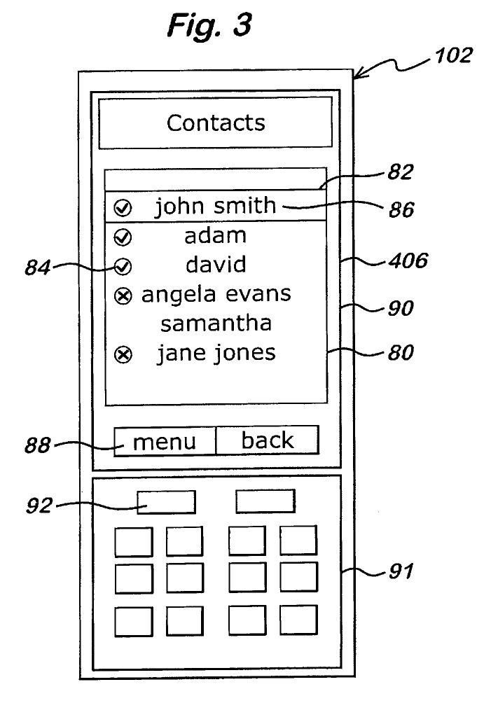

FIG. 3 shows the user device 102 in more detail. The user device 102 comprises a display 90 on which the client user interface 406 is displayed, and a keyboard 91.

The client user interface 406 displayed on the display 90 of the user device 102 is controlled by the client engine to display a contact list 80 associated with the user 102a of the user device 102. Each contact 86 listed in the contact list represents a user of the peer to peer system or PSTN network, stored by the user of the device as a contact. For example the users of the devices 110a and 110b may be stored as contacts in the contact list 80.

Some contacts in the contact list 80 may represent users of the peer to peer system. Contacts representing users of the peer to peer system, such as the contact representing the user of the device 110a, are displayed along side a presence indicator 84 to indicate whether the user is currently logged into the peer to peer system and accordingly whether a communication event may presently be established with the user. Other contacts in the contact list may represent users of the PSTN network such as the user of the user device 110b.

A contact may be selected by controlling the client user interface to display a selection bar 82 over a contact in the contact list 80. The selection bar may be positioned using the keyboard 91, a joystick, a mouse or other directional controller provided by the user interface means of the device 102.

Options for communicating with a selected contact may be displayed by selecting a menu option. The menu option may be selected, for example, by the user pressing a soft key 92 on the keyboard positioned below the menu field 88 displayed by the client user interface.

In accordance with an embodiment of the invention the client program running on the device 102 is arranged to provide the user 102a with alternative options for establishing a communication event in dependence on whether access numbers are available.

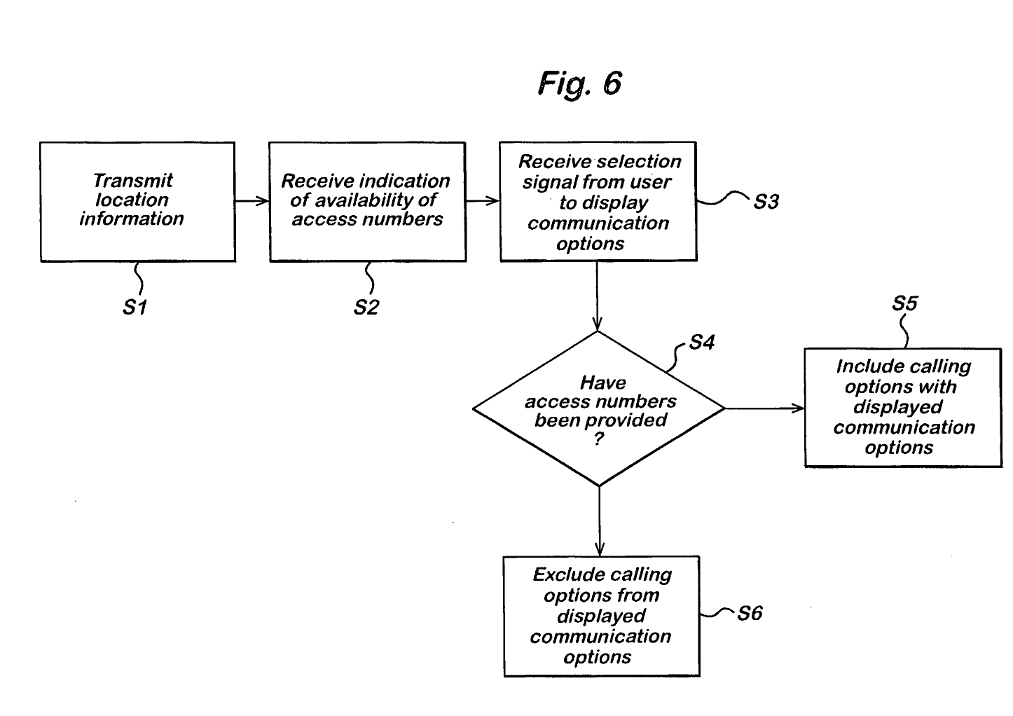

FIG. 6 shows a flow chart for providing communication options to the user 102 in accordance with an embodiment of the invention.

In step S1 the client program 124 running on the device 102 is arranged to transmit information relating to the location of the device 102 to the session node 106.

In step S2 the session node is arranged to transmit a data packet to the client program 124 indicating the availability of access numbers. The availability of access numbers may be indicated by presence of an access number in the data packet. Information relating to the availability of the access number, such as the access number is stored in a data store of the device 102.

In step S3 the client program 124 receives a selection signal from the user to display communication options. The selection signal may be generated by the user 102 pressing the soft key 92 provided on the keyboard beneath the menu field displayed by the client user interface.

In step S4 the client program is arranged to retrieve information relating to the availability of access numbers from the data store of the user device to determine if access numbers are available.

If it is determined that access numbers are available, in step S5 the client is arranged to display a set of communication options which includes the option of establishing a call using the PSTN network.

If it is determined that access numbers are not available, in step S6 the client is arranged to display a set of communication options which does not include the option of establishing a call using the PSTN network.

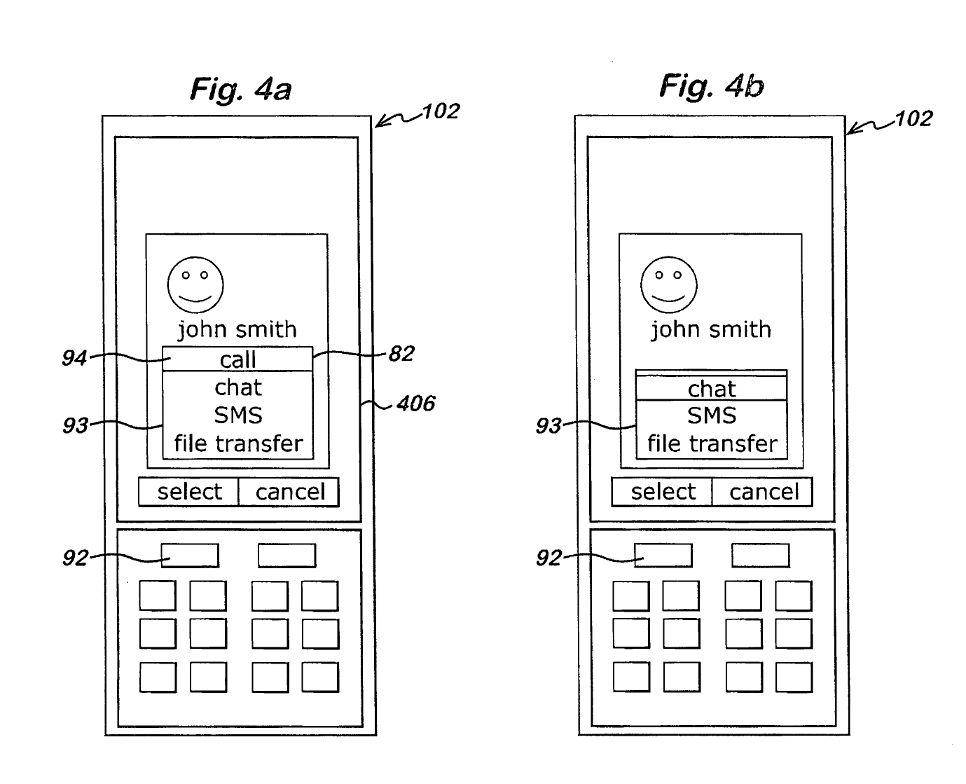

FIG. 4a shows an example of the client user interface that is displayed if it is determined that access numbers are available. As shown in FIG. 4a the communication options 93 displayed in the client user interface 406, include an option 94 to place a call to the selected contact. The user of the device 102 may initiate a call be pressing the soft key 92 when the selection bar 82 is positioned over the call option 94.

FIG. 4b shows an example of the client user interface that is displayed if it is determined that access numbers are not available. As shown in FIG. 4a the communication options 93′ displayed in the client user interface 406, do not include an option to place a call to the selected contact. Communication events that are possible without accessing the PSTN network such as chat, SMS and file transfer are included in the communication options 93′.

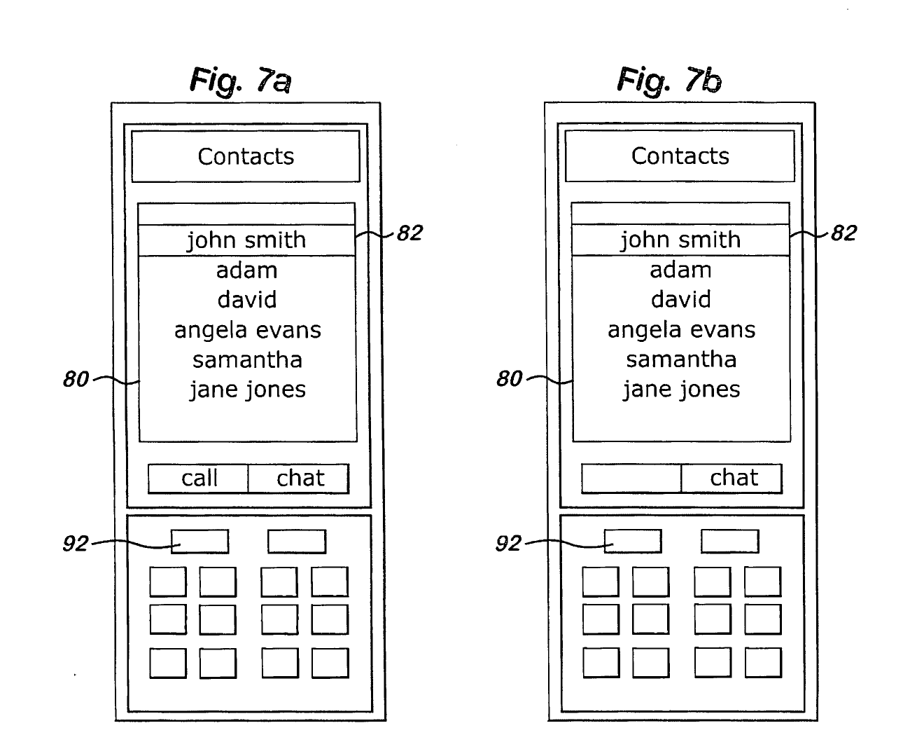

According to an alternative embodiment of the invention the option to call a user may be provided below the contact list 80 as shown in FIG. 7a. In this embodiment of the invention the client program is arranged to determine if access numbers are available when displaying the contact list 80. If it is determined that access numbers are available, the call option is displayed above the soft key 92 as shown in FIG. 7a. The user of the user device may then initiate a call to a contact by pressing the soft key 92 when the selection bar 82 is positioned over the contact that the user wishes to call. However, if it is determined that access numbers are not available, the call option is not displayed above the soft key as shown in FIG. 7b and a call may not be initiated by the user.

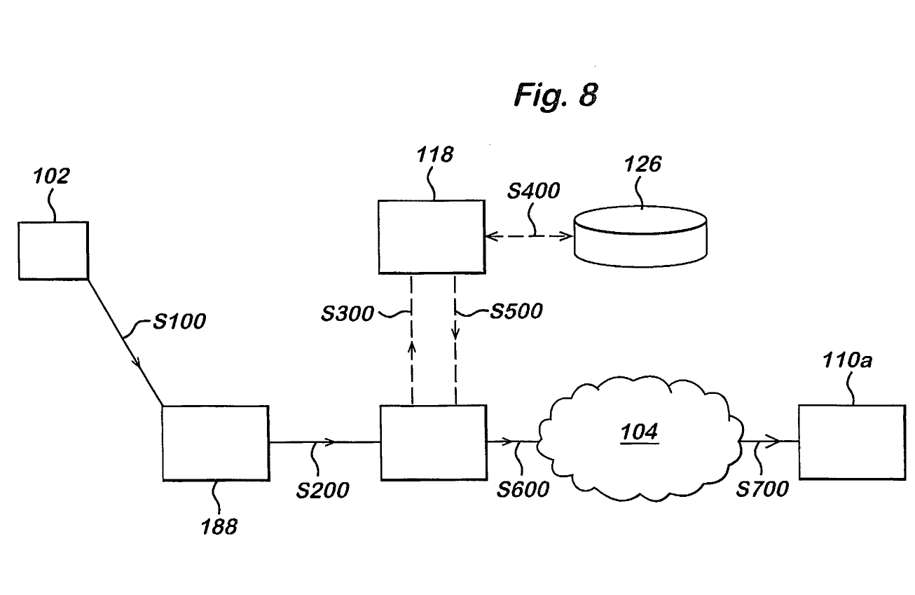

Methods for placing a call using an access number are the subjects of co-pending patent applications. One such method will now be described in with reference to FIG. 8.

In step S100 the user of the user device 102 initiates a call to an entity by selecting a call option. When the user initiates the call the client program 124 is arranged to dial the access number allocated to that entity. The call placed by the client program 124 will therefore include control data that defines the allocated access number. The control data will also include the PSTN number of the user device 102. The dialled access number allocated to entity is used to establish a connection with the PSTN gateway 188 via the GSM audio connection 222.

In step 200 the PSTN gateway 188 is arranged to pass the control data to the inbound node located in the internet 104. The PSTN gateway 188 is arranged to pass control data comprising recognised access numbers to the inbound node 114. The PSTN gateway may recognise numbers that have been provided for use by the call manager 118 by the operator of the PSTN network.

In step S300 the inbound node 114 passes the control data comprising the allocated PSTN number of the called entity and the PSTN number of the user device to the call manager 118.

At step S400 the call manager 118 uses the PSTN number of the device 102 and the access number to search the data store 126 for the address of the called entity.

In step S500 the address of the entity is provided to the inbound node 114.

In step S600 the inbound node 114 uses the address of the entity to enable the call to terminate at the entity.

In step S700 the call is received at the called entity, e.g. device 110a or 110b.

While this invention has been particularly shown and described with reference to preferred embodiments, it will be understood to those skilled in the art that various changes in form and detail may be made without departing from the scope of the invention as defined by the claims.

In particular, according to an alternative embodiment of the invention the call manager is arranged to determine whether access numbers may be provided to the user device 102. According to this embodiment of the invention the session node 106 is arranged to request access numbers from the call manager when a communication instance is allocated to the user device 102. Information relating to the location of the user device, such as the PSTN number of the device, is provided to the call manager from the session node. In response to receiving the request the call manager will determine if access numbers are available for use in the location of the user device. This may be determined by referring to a look up table maintained by the provider of the peer to peer system. If access numbers are available in the location of the user device the call manager will provide the communication instance with the access numbers. However, if access numbers are not available in the location of the user device 102 the call manager will send an indication to the communication instance that access numbers are not available.

In a further alternative embodiment of the invention, in the method described in relation to FIG. 6, if it is determined that access numbers are not available, in step S4 the client is arranged to display a set of communication options which includes a greyed out option for establishing a call using the PSTN network. The greyed out option for establishing a call may not be selected.

Other variations are possible.

What is claimed is:

1. A method of initiating a call from a device executing a client program via an access network comprising:
providing a network node with information associated with the device;
receiving from the network node an indication of whether at least one access number for accessing the access network is available, wherein the availability of the access number is based on the information associated with the device; and
selectively enabling an input means to receive a selection signal from a user of said device to initiate the call using the access number, wherein the input means is only enabled if it is indicated that the access number is available.

2. A method as claimed in claim 1 wherein the step of selectively enabling the input means to receive a selection signal from the user to initiate the call comprises displaying a selectable option for initiating the call if it is indicated that the access number is available.

3. A method as claimed in claim 1 wherein the indication of whether at least one access number for accessing the access network is available is provided in a data packet.

4. A method as claimed in claim 3 wherein the data packet comprises at least part of said at least one access number.

5. A method as claimed in claim 4 wherein the availability of the access number is indicated by the presence of at least part of said at least one access number in the data packet.

6. A method as claimed in claim 3 wherein the availability of the access number is indicated by a flag contained in the data packet.

7. A method as claimed in claim 1 wherein the information associated with the device comprises location information.

8. A method as claimed in claim 1 wherein the information associated with the device comprises device capability information.

9. A method as claimed in claim 1 wherein the access network provides access to a packet switched network.

10. A method as claimed in claim 9 wherein the node is located in the packet switched network.

11. A method as claimed in claim 1 wherein the indication of whether at least one access number for accessing the access network is available is provided from the network node via a packet switched connection.

12. A method as claimed in claim 1 wherein the access network is a PSTN network.

13. A computer program product comprising program code means which when executed by a computer implement the steps according to the method of claim 1.

14. A device arranged to execute a client program for initiating a call via an access network, said device comprising:
transmitting means arranged to provide a network node with information associated with the device;
receiving means arranged to receive from the network node an indication of whether at least one access number for accessing the access network is available, wherein the availability of the access number is based on the information associated with the device; and
input means arranged be selectively enabled to receive a selection signal from a user of said device to initiate the call using the access number, wherein the input means is only enabled if it is indicated that the access number is available.

15. A device as claimed in claim 14 wherein the input means comprises a display means arranged to display selectable options.

16. A device as claimed in claim 15 further comprising a processor arranged to determine if said received indication indicates that the access number is available and to enable the display means to display a selectable option for initiating the call if it is indicated that the access number is available.
